(19) United States
(12) Patent Application Publication
(10) Pub. No.: US 2023/0074499 A1
(43) Pub. Date: Mar. 9, 2023

(54) JOINT CONNECTOR

(71) Applicant: Yazaki Corporation, Tokyo (JP)

(72) Inventors: Ryo HAMADA, Shizuoka (JP); Minoru KUBOTA, Shizuoka (JP)

(73) Assignee: Yazaki Corporation, Tokyo (JP)

(21) Appl. No.: 17/901,222

(22) Filed: Sep. 1, 2022

(30) Foreign Application Priority Data
Sep. 7, 2021 (JP) 2021-145142

(51) Int. Cl. H01R 31/02; H01R 31/06

(52) U.S. Cl. CPC H01R 31/02; H01R 31/06

(57) ABSTRACT

A joint connector includes: busbars; and a housing, in which the busbar includes: output terminal portions extending in a first direction; main bodies extending in a second direction orthogonal to the first direction and connecting the output terminal portions to each other; and input terminal portions connected to the main body, the output terminal portions include: distal end portions positioned at a distal end of the output terminal portions; and a proximal end portion connecting the distal end portions and the main bodies to each other, the housing holds the busbars in a state where the main bodies are arranged in parallel in the first direction and the distal end portions are arranged in parallel in the second direction on a same plane, and proximal end portions of one of the busbars respectively have crossing portions.

### CROSS-REFERENCE TO RELATED APPLICATION(S)

The present application claims priority to and incorporates by reference the entire contents of Japanese Patent Application No. 2021-145142 filed in Japan on Sep. 7, 2021.

### BACKGROUND OF THE INVENTION

### 1. Field of the Invention

The present invention relates to a joint connector.

### 2. Description of the Related Art

There is a conventionally known joint connector. Japanese Patent Application Laid-open No. 2006-19126 discloses a joint connector including a connector housing and a joint terminal attached to the connector housing by press fitting. In the joint connector of Japanese Patent Application Laid-open No. 2006-19126, the joint terminals are attached, in four stages, to the connector housing.

In the joint connector of Japanese Patent Application Laid-open No. 2006-19126, the housing that houses the joint terminal is likely to be thick. A thick joint connector is likely to be restricted in terms of arrangement locations. In addition, the joint connector that houses terminals in stack has difficulty in achieving the thinning of a device that houses the joint connector. Thus, it is desired to achieve height reduction in the joint connector.

### SUMMARY OF THE INVENTION

An object of the present invention is to provide a joint connector capable of reducing the height.

In order to achieve the above mentioned object, a joint connector according to one aspect of the present invention includes a plurality of busbars; and a housing that holds the plurality of busbars, wherein the busbar includes: a plurality of output terminal portions extending in a first direction; a main body extending in a second direction orthogonal to the first direction and connecting the plurality of output terminal portions to each other; and an input terminal portion connected to the main body, the output terminal portion includes: a distal end portion positioned at a distal end of the output terminal portion and connected to a mating terminal; and a proximal end portion connecting the distal end portion and the main body to each other, the housing holds the plurality of busbars in a state where the main bodies are arranged in parallel in the first direction and the distal end portions are arranged in parallel in the second direction on a same plane, and the proximal end portion of one of the busbars has a crossing portion crossing the main body of another one of the busbars.

In order to achieve the above mentioned object, a joint connector according to another aspect of the present invention includes a plurality of conductors; and a housing that holds the plurality of conductors, wherein the conductor includes: a plurality of terminal members each having an output terminal portion and extending in a first direction; and a connecting member extending in a second direction orthogonal to the first direction and connecting the plurality of terminal members to each other, one of the plurality of terminal members including an input terminal portion, the housing holds the plurality of conductors in a state where a plurality of the output terminal portions is arranged in parallel in the second direction on a same plane, and the connecting member of one of the conductors includes a crossing portion crossing the terminal member of another one of the conductors.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a joint connector according to a first embodiment;

FIG. 2 is a perspective view illustrating a busbar according to the first embodiment;

FIG. 3 is a cross-sectional view of the joint connector according to the first embodiment;

FIG. 4 is a cross-sectional view of the joint connector according to the first embodiment;

FIG. 5 is a cross-sectional view of the joint connector according to the first embodiment;

FIG. 6 is a perspective view illustrating a joint connector according to a second embodiment;

FIG. 7 is a transparent perspective view of the joint connector according to the second embodiment;

FIG. 8 is an exploded perspective view illustrating a conductor according to the second embodiment;

FIG. 9 is a cross-sectional view of the joint connector according to the second embodiment; and

FIG. 10 is a cross-sectional view illustrating a boss according to a modification of the embodiment.

### DETAILED DESCRIPTION OF THE PREFERRED EMBODIMENTS

Hereinafter, a joint connector according to an embodiment of the present invention will be described in detail with reference to the drawings. Note that the present invention is not limited by this embodiment. Moreover, components in the following embodiment include those that are easily conceivable for those skilled in the art or substantially identical.

### First Embodiment

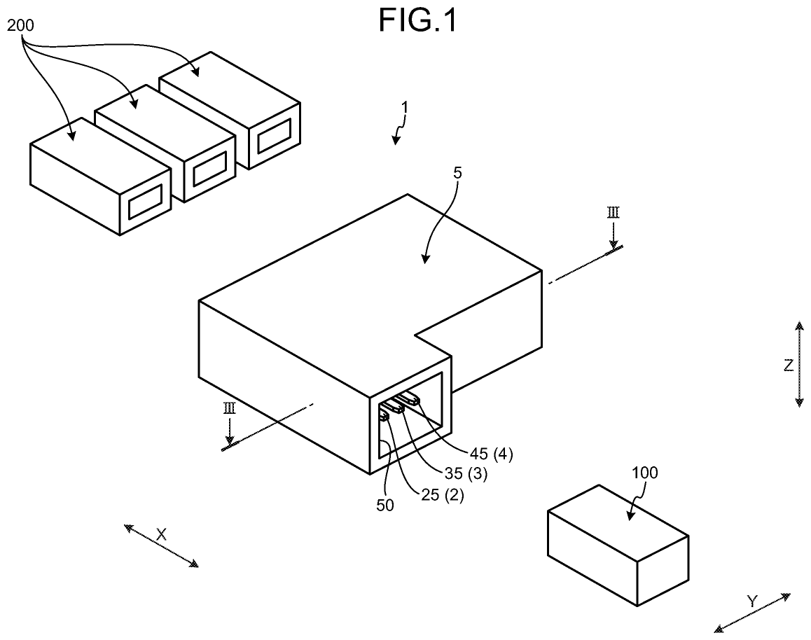

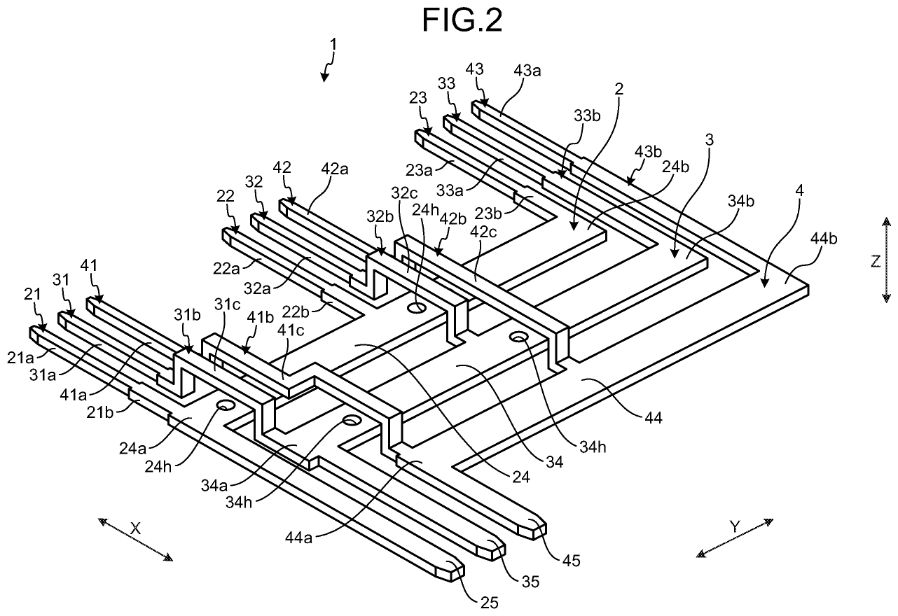

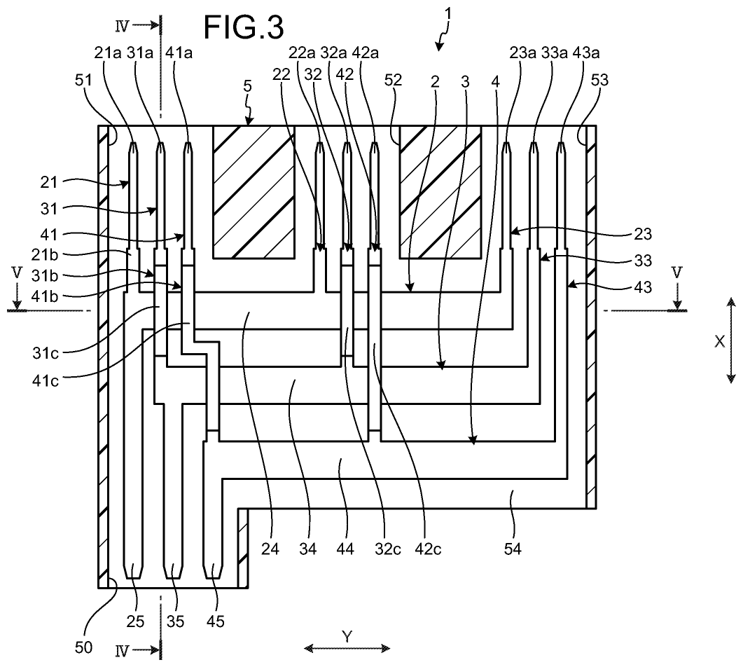

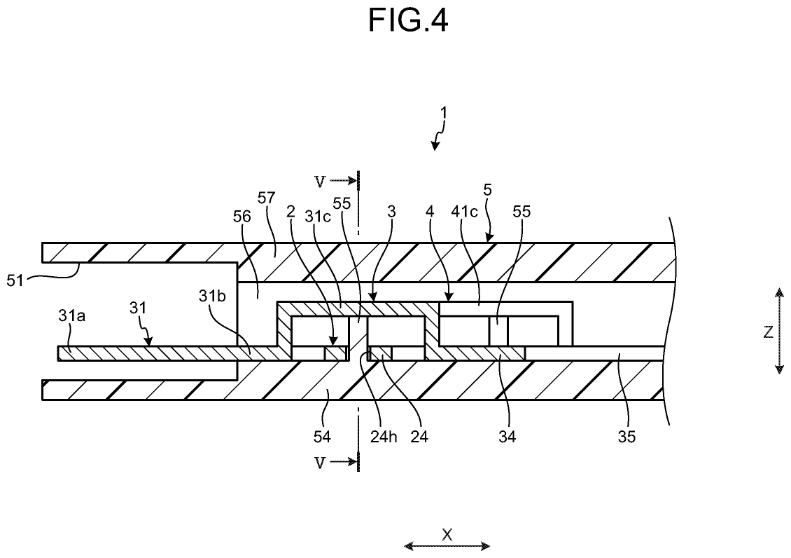

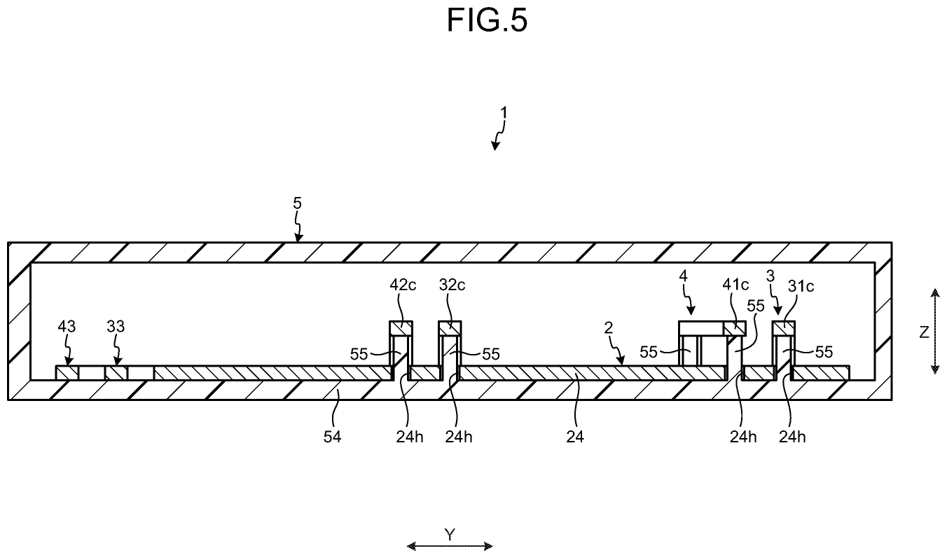

A first embodiment will be described with reference to FIGS. 1 to 5. The present embodiment relates to a joint connector. FIG. 1 is a perspective view illustrating a joint connector of the first embodiment; FIG. 2 is a perspective view illustrating a busbar of the first embodiment; and FIGS. 3 to 5 are cross-sectional views of the joint connector of the first embodiment. FIG. 3 illustrates a cross section taken along line III-III of FIG. 1. FIG. 4 illustrates a cross section taken along line IV-IV in FIG. 3. FIG. 5 illustrates a cross section taken along line V-V in FIG. 3.

A joint connector 1 illustrated in FIG. 1 is mounted on a vehicle such as an automobile, for example. The joint connector 1 connects, for example, a power supply and a control device of a vehicle to a plurality of devices mounted on the vehicle. The joint connector 1 of the present embodiment has a thin shape and thus can be disposed in a narrow space. The joint connector 1 may be arranged on a door of the vehicle. In this case, the joint connector 1 can contribute to thinning of the door.

As illustrated in FIG. 1, the joint connector 1 of the present embodiment includes a first busbar 2, a second busbar 3, a third busbar 4, and a housing 5. Each of the first busbar 2, the second busbar 3, and the third busbar 4 is a plate-shaped conductor formed of a conductive metal. The housing 5 holds the first busbar 2, the second busbar 3, and the third busbar 4. The housing 5 is molded using an insulating synthetic resin, for example. The housing 5 in the illustrated example has a substantially rectangular parallelepiped shape.

The housing 5 has an input-side fitting portion 50 having a rectangular tube shape. A connector 100 on the input side is inserted into the input-side fitting portion 50. Within an internal space of the input-side fitting portion 50, an input terminal portion 25 of the first busbar 2, an input terminal portion 35 of the second busbar 3, and an input terminal portion 45 of the third busbar 4 are exposed. The connector 100 on the input side has a plurality of terminals corresponding to the input terminal portions 25, 35, and 45.

The joint connector 1 connects the connector 100 on the input side to a plurality of connectors 200 as mating connectors. For example, when the connector 100 has a power supply terminal, the joint connector 1 connects the power supply terminal to a power supply terminal of each of the connectors 200. In other words, the joint connector 1 distributes the power supplied via the connector 100 to the plurality of connectors 200. When the connector 100 has a communication terminal, the joint connector 1 connects the communication terminal to a communication terminal of each of the connectors 200. In other words, the joint connector 1 communicably connects the communication device connected to the connector 100 to a communication device connected to each of the connectors 200. When the connector 100 has a ground terminal, the joint connector 1 connects the ground terminal to a ground terminal of each of the connectors 200.

As illustrated in FIG. 2, the busbars 2, 3, and 4 each include single input terminal portions 25, 35, and 45, respectively, while including a plurality of output terminal portions. For example, the first busbar 2 includes the input terminal portion 25, a main body 24, and three output terminal portions 21, 22, and 23. The output terminal portions 21, 22, and 23 are connected to mating terminals of the connector 200. The output terminal portions 21, 22, and 23 are connected to different connectors 200, individually. The input terminal portion 25 is connected to a mating terminal of the connector 100.

In the first busbar 2 in the illustrated example, the three output terminal portions 21, 22, and 23 and the input terminal portion 25 extend in a same direction. The three output terminal portions 21, 22, and 23 are arranged in a direction orthogonal to the extending direction of the output terminal portions 21, 22, and 23.

In the following description, an extending direction of the output terminal portion is referred to as a “first direction X”. The arrangement direction of the output terminal portions 21, 22, and 23 is referred to as a “second direction Y”. The second direction Y is orthogonal to the first direction X. A direction orthogonal to both the first direction X and the second direction Y is referred to as a “third direction Z”. The third direction Z is a thickness direction of the busbars 2, 3, and 4.

The main body 24 extends in the second direction Y and connects the three output terminal portions 21, 22, and 23 to each other. The output terminal portion 21 is connected to a first end 24a of the main body 24, while the output terminal portion 23 is connected to a second end 24b of the main body 24. The output terminal portion 22 is connected to a central portion of the main body 24. The input terminal portion 25 protrudes from the first end 24a of the main body 24 toward the side opposite to the side of the output terminal portions 21, 22, and 23.

The output terminal portion 21 has a distal end portion 21a and a proximal end portion 21b. The distal end portion 21a is a portion connected to the mating terminal, and is located at the distal end of the output terminal portion 21. The distal end portion 21a has a rectangular column shape. The proximal end portion 21b is a portion connecting the distal end portion 21a and the main body 24 to each other.

Similarly, the output terminal portion 22 has a distal end portion 22a and a proximal end portion 22b, while the output terminal portion 23 has a distal end portion 23a and a proximal end portion 23b. In the first busbar 2, the output terminal portions 21, 22, and 23, the main body 24, and the input terminal portion 25 are on a same plane. That is, in the first busbar 2, the output terminal portions 21, 22, and 23, the main body 24, and the input terminal portion 25 are at the same position in the third direction Z.

The second busbar 3 includes an input terminal portion 35, a main body 34, and three output terminal portions 31, 32, and 33. The output terminal portions 31, 32, and 33 extend in the first direction X. The main body 34 extends in the second direction Y and connects the three output terminal portions 31, 32, and 33 to each other. The output terminal portion 31 is connected to a first end 34a of the main body 34. The output terminal portion 33 is connected to a second end 34b of the main body 34. The output terminal portion 32 is connected to a central portion of the main body 34. The input terminal portion 35 protrudes from the first end 34a of the main body 34 toward the side opposite to the side of the output terminal portions 31, 32, and 33. In the second busbar 3, the distal end portions 31a, 32a, and 33a, the main body 34, and the input terminal portion 35 are on a same plane.

The output terminal portion 31 has a distal end portion 31a and a proximal end portion 31b. The distal end portion 31a is a portion connected to the mating terminal, and is located at the distal end of the output terminal portion 31. The distal end portion 31a has a rectangular column shape. The proximal end portion 31b is a portion connecting the distal end portion 31a and the main body 34 to each other. The proximal end portion 31b has a crossing portion 31c. The crossing portion 31c is formed so as to be able to cross the main body 24 of the first busbar 2. More specifically, the proximal end portion 31b is bent so as to allow the crossing portion 31c to protrude in the third direction Z with respect to the distal end portion 31a and the main body 34.

The output terminal portion 32 includes a distal end portion 32a and a proximal end portion 32b. The proximal end portion 32b includes a crossing portion 32c formed similarly to the crossing portion 31c. The crossing portion 32c is formed so as to be able to cross the main body 24. The output terminal portion 33 includes a distal end portion 33a and a proximal end portion 33b. The proximal end portion 33b has a flat plate shape and has no crossing portion.

The third busbar 4 includes an input terminal portion 45, a main body 44, and three output terminal portions 41, 42, and 43. The output terminal portions 41, 42, and 43 extend in the first direction X. The main body 44 extends in the second direction Y and connects the three output terminal portions 41, 42, and 43 to each other. The output terminal portion 41 is connected to a first end 44a of the main body 44. The output terminal portion 43 is connected to a second end 44b of the main body 44. The output terminal portion 42 is connected to a central portion of the main body 44. The input terminal portion 45 protrudes from the first end 44a of the main body 44 toward the side opposite to the side of the output terminal portions 41, 42, and 43. In the third busbar 4, the distal end portions 41a, 42a, and 43a, the main body 44, and the input terminal portion 45 are on a same plane.

The output terminal portion 41 includes a distal end portion 41a and a proximal end portion 41b. The distal end portion 41a is a portion connected to the mating terminal, and is located at the distal end of the output terminal portion 41. The distal end portion 41a has a rectangular column shape. The proximal end portion 41b is a portion connecting the distal end portion 41a and the main body 44 to each other. The proximal end portion 41b has a crossing portion 41c. The crossing portion 41c is formed so as to be able to cross the main body 24 of the first busbar 2 and the main body 34 of the second busbar 3. More specifically, the proximal end portion 41b is bent so as to allow the crossing portion 41c to protrude in the third direction Z with respect to the distal end portion 41a and the main body 44.

The output terminal portion 42 includes a distal end portion 42a and a proximal end portion 42b. The proximal end portion 42b includes a crossing portion 41c formed substantially similarly to the crossing portion 42c. The crossing portion 42c is formed so as to be able to cross the main body 24 and the main body 34. The output terminal portion 43 has a distal end portion 43a and a proximal end portion 43b. The proximal end portion 43b has a flat plate shape and has no crossing portion.

The main body 24 of the first busbar 2 has a plurality of through holes 24h. The through hole 24h penetrates the main body 24 in a thickness direction of the main body 24. The through hole 24h is disposed at a position facing the crossing portions 31c, 41c, 32c, and 42c. The main body 34 of the second busbar 3 has a plurality of through holes 34h. The through hole 34h is disposed at a position facing the crossing portions 41c and 42c. The cross-sectional shapes of the through holes 24h and 34h are circular, for example.

As illustrated in FIG. 3, the housing 5 holds the first busbar 2, the second busbar 3, and the third busbar 4. The housing 5 includes a first fitting portion 51, a second fitting portion 52, and a third fitting portion 53. The fitting portions 51, 52, and 53 open toward the side opposite to the input-side fitting portion 50 side. The fitting portions 51, 52, and 53 have rectangular tube shapes. The first fitting portion 51, the second fitting portion 52, and the third fitting portion 53 are arranged in this order in the second direction Y.

The output terminal portions 21, 31, and 41 are exposed to an internal space of the first fitting portion 51. The housing 5 holds the busbars 2, 3, and 4 so as to allow the output terminal portions 21, 31, and 41 to be arranged in parallel in this order in the second direction Y. In a state where the busbars 2, 3, and 4 are held by the housing 5, the distal end portions 21a, 31a, and 41a of the output terminal portions 21, 31, and 41 are located on a same plane. In the housing 5 in the illustrated example, the distal end portions 21a, 31a, and 41a are arranged in parallel.

The output terminal portions 22, 32, and 42 are exposed to an internal space of the second fitting portion 52. The housing 5 holds the busbars 2, 3, and 4 so as to allow the output terminal portions 22, 32, and 42 to be arranged in parallel in this order in the second direction Y. In a state where the busbars 2, 3, and 4 are held by the housing 5, the distal end portions 22a, 32a, and 42a of the output terminal portions 22, 32, and 42 are located on a same plane. In the housing 5 in the illustrated example, the distal end portions 22a, 32a, and 42a are arranged in parallel.

The output terminal portions 23, 33, 43 are exposed to an internal space of the third fitting portion 53. The housing 5 holds the busbars 2, 3, and 4 so as to allow the output terminal portions 23, 33, and 43 to be arranged in parallel in this order in the second direction Y. In a state where the busbars 2, 3, and 4 are held by the housing 5, the distal end portions 23a, 33a, and 43a of the output terminal portions 23, 33, and 43 are located on a same plane. In the housing 5 in the illustrated example, the distal end portions 23a, 33a, and 43a are arranged in parallel. Furthermore, the distal end portions 21a, 31a, and 41a of the first fitting portion 51, the distal end portions 22a, 32a, and 42a of the second fitting portion 52, and the distal end portions 23a, 33a, 43a of the third fitting portion 53 are located on a same plane. That is, all the distal end portions 21a, 31a, 41a, 22a, 32a, 42a, 23a, 33a, and 43a are arranged on the same plane.

In the housing 5, the main bodies 24, 34, and 44 are arranged in parallel in the first direction X. The main bodies 24, 34, and 44 extend in the second direction Y individually and are arranged in the first direction X. The housing 5 in the illustrated example holds the busbars 2, 3, and 4 by arranging the main bodies 24, 34, and 44 respectively in parallel.

As illustrated in FIGS. 3 and 4, the housing 5 has a bottom wall 54 that supports the busbars 2, 3, and 4. The housing 5 in the illustrated example includes: a main body having a bottom wall 54 and a side wall 56; and a lid 57 that is engaged with the main body. The fitting portions 50, 51, 52, and 53 are each provided in the main body. The bottom wall 54 may have an engaging portion that is engaged with the busbars 2, 3, and 4. The bottom wall 54 supports the main body 24, the output terminal portions 21, 22, and 23, and the input terminal portion 25 of the first busbar 2. The bottom wall 54 supports the main bodies 34 and 44, the output terminal portions 31, 32, 33, 41, 42, and 43, and the input terminal portions 35 and 45 of the second busbar 3 and the third busbar 4.

As illustrated in FIG. 4, the crossing portion 31c crosses the main body 24 while maintaining a necessary insulation distance from the main body 24 of the first busbar 2. In other words, the proximal end portion 31b is bent so as to form a gap from the main body 24 in the first direction X and the third direction Z.

The housing 5 has a plurality of bosses 55. The boss 55 protrudes from the bottom wall 54 in the third direction Z. The boss 55 has a shape that can be fitted to the through holes 24h and 34h. The shape of the boss 55 is a cylindrical shape, for example. As illustrated in FIG. 4, the boss 55 is inserted into the through hole 24h of the first busbar 2 and supports the crossing portion 31c. As illustrated in FIG. 5, the boss 55 inserted into the other through hole 24h of the first busbar 2 supports each of the crossing portions 41c, 32c, and 42c.

The boss 55 inserted into the through hole 34h of the second busbar 3 supports the crossing portions 41c and 42c. The boss 55 can be used to position the busbars 2 and 3 in the first direction X and the second direction Y. In addition, the boss 55 can maintain a necessary distance between the first busbar 2 and the busbars 3 and 4 in the third direction Z, and can maintain a necessary distance between the second busbar 3 and the third busbar 4.

As described above, the joint connector 1 of the present embodiment includes the plurality of busbars 2, 3, and 4, and the housing 5. The housing 5 holds the plurality of busbars 2, 3, and 4. The busbars 2, 3, and 4 include: a plurality of output terminal portions extending in the first direction X; a main body extending in the second direction Y and connecting the plurality of output terminal portions; and an input terminal portion. For example, the first busbar 2 includes: the plurality of output terminal portions 21, 22, and 23; the main body 24 connecting the output terminal portions 21, 22, and 23; and the input terminal portion 25 connected to the main body 24.

The output terminal portions of the busbars 2, 3, and 4 each include: a distal end portion positioned at a distal end of the output terminal portion; and a proximal end portion connecting the distal end portion to the main body. For example, the output terminal portions 21, 22, and 23 of the first busbar 2 have distal end portions 21a, 22a, and 23a connected to mating terminals, and proximal end portions 21b, 22b, and 23b, respectively. The housing 5 holds the plurality of busbars 2, 3, and 4 in a state where the main bodies 24, 34, and 44 are arranged in parallel in the first direction X and the distal end portions 21a, 31a, 41a, 22a, 32a, 42a, 23a, 33a, and 43a are arranged in parallel in the second direction Y on the same plane.

The proximal end portion of one busbar has a crossing portion crossing the main body of another busbar. For example, the proximal end portions 31b and 32b of the second busbar 3 includes the crossing portions 31c and 32c crossing the main body 24 of the first busbar 2. The proximal end portions 41b and 42b of the third busbar 4 have crossing portions 41c and 42c crossing the main body 24 of the first busbar 2 and the main body 34 of the second busbar 3.

In this manner, by arranging the distal end portions 21a, 31a, 41a, 22a, 32a, 42a, 23a, 33a, and 43a of the plurality of busbars 2, 3, and 4 on the same plane in the joint connector 1 of the present embodiment, it is possible to achieve reduction of the height of the joint connector 1. Accordingly, the joint connector 1 according to the present embodiment can achieve the reduction of the height of the joint connector 1.

In the present embodiment, the distal end portion and the main body are located on the same plane in one busbar. For example, in the second busbar 3, the distal end portions 31a, 32a, and 33a, and the main body 34, are located on the same plane. Furthermore, the crossing portion protrudes in the third direction with respect to the distal end portions 31a, 32a, and 33a and the main body 34. In addition, the distal end portions 21a, 31a, 41 a, 22a, 32a, 42a, 23a, 33a, and 43a of the plurality of busbars 2, 3, and 4, and the main bodies 24, 34, and 44, are located on the same plane. With such a configuration, it is possible to reduce the height of the joint connector 1. This configuration also enables the plurality of connectors 200 having the same shape to be connected to the joint connector 1.

The main bodies 24 and 34 of the present embodiment respectively have through holes 24h and 34h formed at positions facing the crossing portions 31c, 32c, 41c, and 42c. The housing 5 includes the boss 55 that is inserted through the through holes 24h and 34h and supports the connection portions 31c, 32c, 41c, and 42c. The boss 55 can appropriately keep the size of the gap between the main bodies 24 and 34 and the connection portions 31c, 32c, 41c, and 42c. Moreover, the boss 55 can reinforce the busbars 2 and 3.

Incidentally, the number of output terminal portions included in the busbars 2, 3, and 4 is not limited to three being the number in the illustrated example. The number of output terminal portions included in one busbar may be two or four or more. The number of fitting portions included in the housing 5 is determined according to the number of output terminal portions. The number of busbars held by the housing 5 is not limited to three being the number in the illustrated example. The number of busbars held by the housing 5 may be two or four or more.

The protruding directions of the input terminal portions 25, 35, and 45 with respect to the main bodies 24, 34, and 44 are not limited to the directions in the illustrated example. For example, the input terminal portions 25, 35, and 45 may protrude in the second direction Y. The housing 5 may be formed by in-mold processing on the busbars 2, 3, and 4.

### Second Embodiment

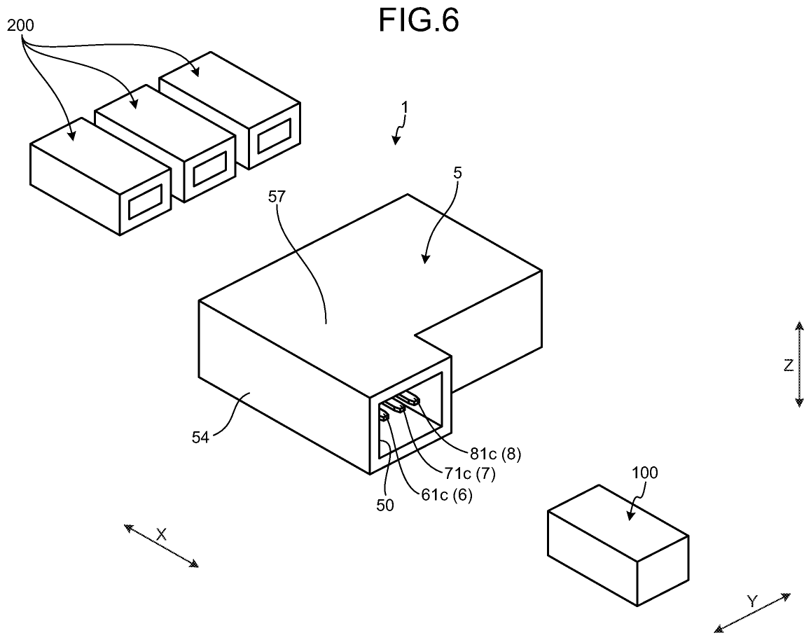

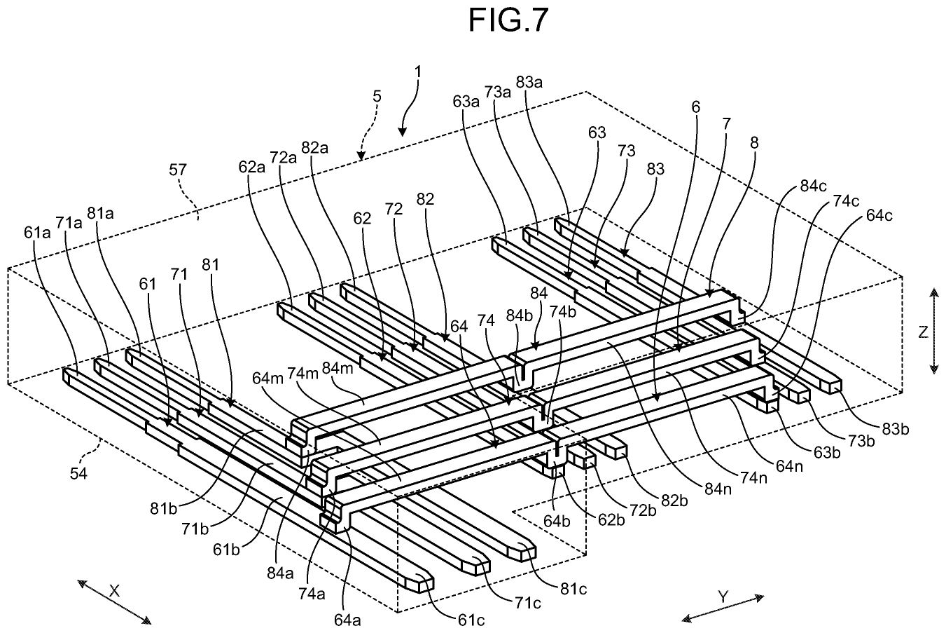

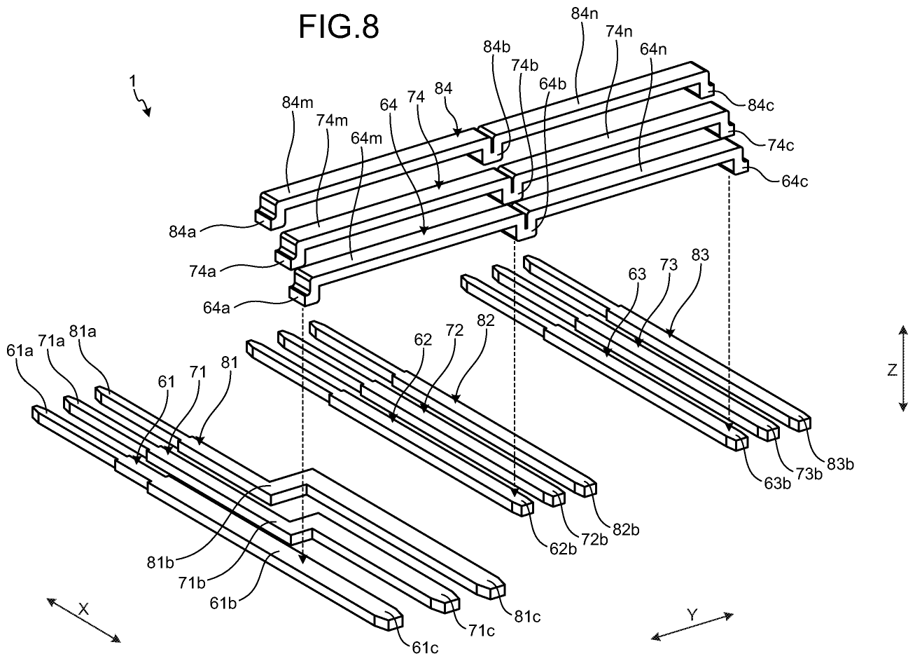

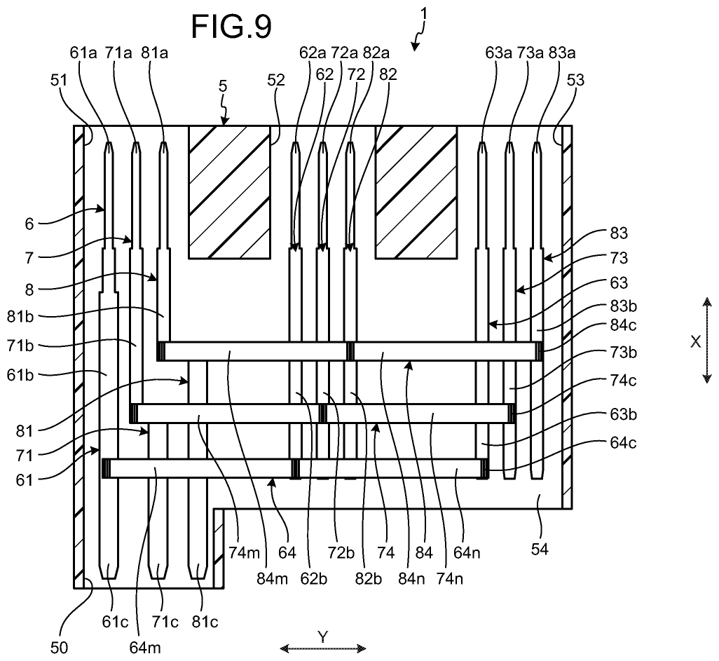

A second embodiment will be described. FIG. 6 is a perspective view of a relay connector according to the second embodiment; FIG. 7 is a perspective view of a conductor according to the second embodiment; FIG. 8 is an exploded perspective view of the conductor according to the second embodiment; and FIG. 9 is a cross-sectional view of a joint connector according to the second embodiment. The second embodiment is different from the first embodiment in that the conductor includes a plurality of members, for example.

As illustrated in FIG. 6, the joint connector 1 according to the second embodiment includes a first conductor 6, a second conductor 7, a third conductor 8, and a housing 5. Similarly to the joint connector 1 of the first embodiment, the joint connector 1 connects a connector 100 on the input side to a plurality of mating connectors 200.

As illustrated in FIGS. 7 and 8, each of the first conductor 6, the second conductor 7, and the third conductor 8 is constituted with a combination of plate-shaped conductors. The first conductor 6 includes a plurality of terminal members 61, 62, and 63 and a connecting member 64. The second conductor 7 includes a plurality of terminal members 71, 72, and 73 and a connecting member 74. The third conductor 8 includes a plurality of terminal members 81, 82, and 83 and a connecting member 84.

Each of the terminal members 61, 62, and 63 is formed of a conductive metal plate and has a flat plate shape. The terminal member 61 includes an output terminal portion 61a, a base portion 61b, and an input terminal portion 61c. The output terminal portion 61a, the base portion 61b, and the input terminal portion 61c extend in straight line. The output terminal portion 61a is connected to one end of the base portion 61b, while the input terminal portion 61c is connected to the other end of the base portion 61b. The output terminal portion 61a is connected to a terminal of the mating connector 200. The input terminal portion 61c is connected to a terminal of the connector 100 on the input side.

The terminal member 62 includes an output terminal portion 62a and a base portion 62b. The output terminal portion 62a and the base portion 62b extend in straight line. The output terminal portion 62a is a portion connected to a terminal of the mating connector 200, and is connected to one end of the base portion 62b. The terminal member 63 has the same shape as the terminal member 62, and has an output terminal portion 63a and a base portion 63b.

The connecting member 64 is formed of a conductive metal plate. The connecting member 64 includes flat plate-shaped crossing portions 64m and 64n, a first contact portion 64a, a second contact portion 64b, and a third contact portion 64c. The first contact portion 64a, the second contact portion 64b, and the third contact portion 64c are each formed by bending a part of a metal plate. The first contact portion 64a is disposed at one end of the connecting member 64, while the third contact portion 64c is disposed at the other end of the connecting member 64. The second contact portion 64b is disposed at a central portion of the connecting member 64. The crossing portion 64m connects the first contact portion 64a and the second contact portion 64b to each other. The crossing portion 64n connects the second contact portion 64b and the third contact portion 64c to each other. Each of the contact portions 64a, 64b, and 64c protrudes in the thickness direction with respect to the crossing portions 64m and 64n.

The first contact portion 64a is electrically connected to the base portion 61b of the terminal member 61. The second contact portion 64b is electrically connected to the base portion 62b of the terminal member 62. The third contact portion 64c is electrically connected to the base portion 63b of the terminal member 63.

Each of the terminal members 71, 72, and 73 of the second conductor 7 is formed of a conductive metal plate and has a flat plate shape. The terminal member 71 includes an output terminal portion 71a, a base portion 71b, and an input terminal portion 71c. The output terminal portion 71a is connected to a terminal of the mating connector 200. The input terminal portion 71c is connected to a terminal of the connector 100 on the input side.

The output terminal portion 71a, the base portion 71b, and the input terminal portion 71c extend substantially in straight line. The base portion 71b has a zigzag shape so as to maintain a distance between the adjacent input terminal portions 61c and 71c. The terminal members 72 and 73 have the same shape as the terminal members 62 and 63, and have output terminal portions 72a and 73a and base portions 72b and 73b.

The connecting member 74 has the same shape as the connecting member 64, and includes flat plate-shaped crossing portions 74m and 74n, a first contact portion 74a, a second contact portion 74b, and a third contact portion 74c. The first contact portion 74a is electrically connected to the base portion 71b of the terminal member 71. The second contact portion 74b is electrically connected to the base portion 72b of the terminal member 72. The third contact portion 74c is electrically connected to the base portion 73b of the terminal member 73.

Each of the terminal members 81, 82, and 83 of the third conductor 8 is formed of a conductive metal plate and has a flat plate shape. The terminal member 81 includes an output terminal portion 81a, a base portion 81b, and an input terminal portion 81c. The output terminal portion 81a is connected to a terminal of the mating connector 200. The input terminal portion 81c is connected to a terminal of the connector 100 on the input side.

The output terminal portion 81a, the base portion 81b, and the input terminal portion 81c extend substantially in straight line. The base portion 81b has a zigzag shape so as to maintain a distance between the adjacent input terminal portions 71c and 81c. The terminal members 82 and 83 have the same shape as the terminal members 62 and 63, and have output terminal portions 82a and 83a and base portions 82b and 83b.

The connecting member 84 has the same shape as the connecting member 64, and includes flat plate-shaped crossing portions 84m and 84n, a first contact portion 84a, a second contact portion 84b, and a third contact portion 84c. The first contact portion 84a is electrically connected to the base portion 81b of the terminal member 81. The second contact portion 84b is electrically connected to the base portion 82b of the terminal member 82. The third contact portion 84c is electrically connected to the base portion 83b of the terminal member 83.

As illustrated in FIGS. 7 and 9, the housing 5 holds the first conductor 6, the second conductor 7, and the third conductor 8. More specifically, the bottom wall 54 of the housing 5 holds the terminal members 61, 62, 63, 71, 72, 73, 81, 82, and 83 so as to be extended in the first direction X. The housing 5 holds the first conductor 6, the second conductor 7, and the third conductor 8 in a state where the plurality of output terminal portions 61a, 71a, 81a, 62a, 72a, 82a, 63a, 73a, and 83a are arranged in parallel in the second direction Y on the same plane.

As illustrated in FIG. 9, the output terminal portions 61a, 71a, 81a are exposed to an internal space of the first fitting portion 51. The output terminal portions 62a, 72a, and 82a are exposed to the internal space of the second fitting portion 52. The output terminal portions 63a, 73a, 83a are exposed to the internal space of the third fitting portion 53. The input terminal portions 61c, 71c, and 81c are exposed to the internal space of the input-side fitting portion 50.

The housing 5 connects the connecting members 64, 74, and 84 to the terminal members 61, 62, 63, 71, 72, 73, 81, 82, and 83. More specifically, the lid 57 of the housing 5 holds the connecting members 64, 74, and 84 while pressing the connecting members 64, 74, and 84 toward the terminal members 61, 62, 63, 71, 72, 73, 81, 82, and 83. For example, the connecting member 64 is pressed toward the terminal members 61, 62, and 63 by the lid 57, so as to be electrically connected to the terminal members 61, 62, and 63. This allows the terminal members 61, 62, and 63 to be electrically connected to each other via the connecting member 64.

Similarly, the connecting member 74 is pressed toward the terminal members 71, 72, and 73 by the lid 57, so as to be electrically connected to the terminal members 71, 72, and 73. The connecting member 84 is pressed toward the terminal members 81, 82, and 83 by the lid 57, so as to be electrically connected to the terminal members 81, 82, and 83. The lid 57 may include a holder that holds the connecting members 64, 74, and 84.

As described above, the joint connector 1 of the second embodiment includes: the plurality of conductors 6, 7, and 8; and the housing 5 that holds the plurality of conductors 6, 7, and 8. The conductors 6, 7, and 8 include: a plurality of terminal members extending in the first direction X; and a connecting member that connects the plurality of terminal members to each other. One of the plurality of terminal members includes an input terminal portion. For example, the first conductor 6 includes: the plurality of terminal members 61, 62, and 63 respectively having output terminal portions 61a, 62a, and 63a; and a connecting member 64 that connects the terminal members 61, 62, and 63 to each other. One of the terminal members 61 includes the input terminal portion 61c.

The housing 5 holds the plurality of conductors 6, 7, and 8 in a state where the plurality of output terminal portions 61a, 71a, 81a, 62a, 72a, 82a, 63a, 73a, and 83a are arranged in parallel in the second direction Y on the same plane. The connecting member of one conductor has a crossing portion crossing the terminal members of the other conductors. For example, the crossing portion 64m of the first conductor 6 crosses the terminal member 71 of the second conductor 7 and the terminal member 81 of the third conductor 8, and the crossing portion 64n crosses the terminal member 72 of the second conductor 7 and the terminal member 82 of the third conductor 8. In other words, the connecting member 64 connects the terminal members 61, 62, and 63 to each other while crossing the terminal members 71, 81, 72, and 82. The joint connector 1 according to the present embodiment can achieve reduction of the height of the joint connector 1.

In the joint connector 1 of the present embodiment, the number of terminal members can be adjusted according to the number of connectors 200 to be connected. For example, when there are two connectors 200 connected to the joint connector 1, the terminal members 62, 72, and 82 or the terminal members 63, 73, and 83 can be omitted. In the joint connector 1 of the present embodiment, the pitch of the terminal members can be freely changed. For example, the pitch of the terminal members 61, 62, and 63 in the second direction Y can be changed without changing the shapes of the terminal members 61, 62, or 63. In this case, the connecting member 64 corresponding to the pitch of the terminal members 61, 62, and 63 is used.

The connecting members 64, 74, and 84 may be fixed to the terminal members 61, 62, 63, 71, 72, 73, 81, 82, and 83 by a method such as laser welding or ultrasonic welding.

The housing 5 of the second embodiment may include the boss 55 that supports the crossing portion of the connecting members 64, 74, and 84. In this case, the terminal member may be provided with a through hole through which the boss 55 can be inserted.

The housing 5 may be formed by in-molding processing on the terminal members 61, 62, 63, 71, 72, 73, 81, 82, and 83. In this case, the housing 5 holds the terminal member in a state where contact portions of the terminal member with the connecting members 64, 74, and 84 are exposed.

Modification of Above-Described Embodiments

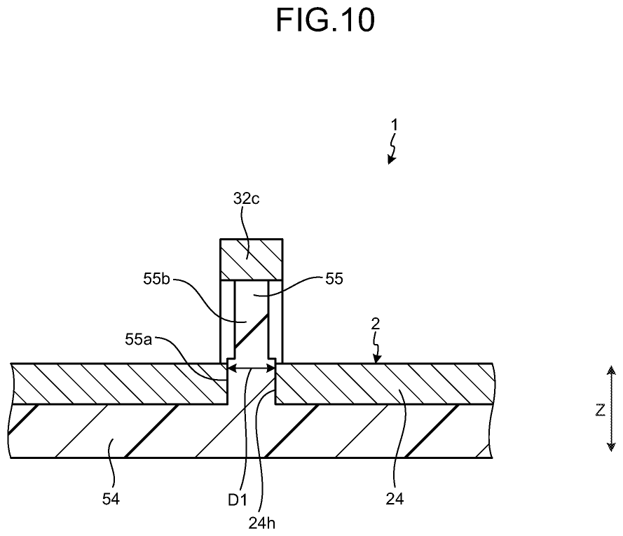

The boss 55 may have a press-fitting portion that is press-fitted into the main body or the terminal member. FIG. 10 is a cross-sectional view illustrating a boss according to a modification of the embodiment. The boss 55 illustrated in FIG. 10 includes a press-fitting portion 55a and a small-diameter portion 55b. The press-fitting portion 55a is disposed at the proximal end portion of the boss 55. The small-diameter portion 55b is a portion on the distal end side of the boss 55.

An outer diameter Dl of the press-fitting portion 55a is determined to have a size that allows the press-fitting portion 55a to be press-fitted into the through hole 24h. The press-fitting portion 55a may have a rib for being press-fitted into the through hole 24h. The outer diameter of the small-diameter portion 55b is smaller than the outer diameter of the press-fitting portion 55a. The press-fitting portion 55a can fix the main body 24 of the first busbar 2 and appropriately maintain the distance between the crossing portion 32c and the main body 24. The press-fitting portion 55a may be provided in the boss 55 inserted into the through hole 34h or the boss 55 inserted into the terminal member of the second embodiment.

The techniques disclosed in the above embodiments and modification can be executed in appropriate combination with each other.

The joint connector according to the present embodiment includes a crossing portion and allows terminal portions to be arranged in parallel on a same plane. The joint connector of the present embodiment can achieve height reduction.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A joint connector comprising:
a plurality of busbars; and
a housing that holds the plurality of busbars, wherein
the busbar includes: a plurality of output terminal portions extending in a first direction; a main body extending in a second direction orthogonal to the first direction and connecting the plurality of output terminal portions to each other; and an input terminal portion connected to the main body,
the output terminal portion includes: a distal end portion positioned at a distal end of the output terminal portion and connected to a mating terminal; and a proximal end portion connecting the distal end portion and the main body to each other,
the housing holds the plurality of busbars in a state where the main bodies are arranged in parallel in the first direction and the distal end portions are arranged in parallel in the second direction on a same plane, and
the proximal end portion of one of the busbars has a crossing portion crossing the main body of another one of the busbars.

2. The joint connector according to claim 1, wherein
the one busbar has the distal end portion and the main body located on a same plane,
the crossing portion protrudes with respect to the distal end portion and the main body in a direction orthogonal to each of the first direction and the second direction, and
the distal end portions and the main bodies of the plurality of busbars are located on a same plane.

3. The joint connector according to claim 1, wherein
the main body has a through hole formed at a position facing the crossing portion, and
the housing includes a boss that is inserted into the through hole and supports the crossing portion.

4. The joint connector according to claim 2, wherein
the main body has a through hole formed at a position facing the crossing portion, and
the housing includes a boss that is inserted into the through hole and supports the crossing portion.

5. A joint connector comprising:
a plurality of conductors; and
a housing that holds the plurality of conductors, wherein
the conductor includes: a plurality of terminal members each having an output terminal portion and extending in a first direction; and a connecting member extending in a second direction orthogonal to the first direction and connecting the plurality of terminal members to each other, one of the plurality of terminal members including an input terminal portion,
the housing holds the plurality of conductors in a state where a plurality of the output terminal portions is arranged in parallel in the second direction on a same plane, and
the connecting member of one of the conductors includes a crossing portion crossing the terminal member of another one of the conductors.
